(19) United States
(12) Patent Application Publication
(10) Pub. No.: US 2025/0113837 A1
(43) Pub. Date: Apr. 10, 2025

(54) POWDERED COMPOSITION COMPRISING A SOLID PLANT-BASED FAT

(71) Applicant: Firmenich SA, Satigny (CH)

(72) Inventors: Jian ZHANG, Langhorne, PA (US); Howard MUNT, Satigny (CH); Jingyu FENG, Newtown, PA (US)

(73) Assignee: Firmenich SA, Satigny (CH)

(21) Appl. No.: 17/600,962

(22) PCT Filed: Nov. 10, 2020
(86) PCT No.: PCT/EP2020/081588

§ 371 Date: Oct. 1, 2021

Related U.S. Application Data
(60) Provisional application No. 62/941,938, filed on Nov. 29, 2019.

(30) Foreign Application Priority Data
Dec. 20, 2019 (EP) 19219140.1

(51) Int. Cl. A23D 9/05; A23D 7/05; A23K 20/158; A23L 27/26; A23L 29/10

(52) U.S. Cl. CPC A23D 9/05; A23D 7/05; A23K 20/158; A23L 27/26; A23L 29/10

(57) ABSTRACT

The present disclosure relates to a powdered composition, preferably a flavored powdered composition comprising a solid plant-based fat to impart thermal triggered release properties when incorporated in food products such as meat analogues. The disclosure further relates to the use of a flavored powdered composition as an animal fat replacer in food, pet-food or feed products. Finally, the disclosure concerns a method for preparing said flavored powdered composition and a food product comprising said flavored powdered composition.

### CROSS-REFERENCE TO RELATED APPLICATIONS

The present application claims priority to U.S. Provisional Application No. 62/941,938, filed Nov. 29, 2019, and European Patent Application No. 19219140.1, filed Dec. 20, 2019, both of which are hereby incorporated by reference as though set forth herein in their entireties.

### TECHNICAL FIELD

The present disclosure relates to a powdered composition, preferably a flavored powdered composition comprising a solid plant-based fat to impart thermal triggered release properties when incorporated in consumer products, preferably food products such as meat analogues. The disclosure further relates to the use of a flavored powdered composition as an animal fat replacer in food, pet-food or feed products. Finally, the disclosure concerns a method for preparing said powdered composition and a food product comprising said flavored powdered composition.

### Background of the Disclosure and Problems to be Solved

In spite of the intense amount of work carried out in the effort to make acceptable meat analogues, the resulting products only superficially resemble natural meat. For example, many important flavor and taste compounds are generated during cooking, but until now, not any meat analogue of the market provides such flavor during cooking.

Indeed, these food products often require thermal treatment during preparation and are consumed while warm. Thermal triggered flavor release is therefore highly desirable in these applications (i.e. grill, baking, microwave, etc.). Flavor release at elevated temperatures can minimize flavor loss, improve flavor intensity, and bring new sensorial experience during food preparation and consumption. Powdered composition known in the prior art release the actives upon dissolution in high water activity applications. However, these conventional technologies have little control on active release, particularly flavor release via temperature.

Consequently, there is a need of providing a technical solution to impart thermal triggered release properties to a powdered composition that will be suitable in different applications when incorporated in a consumer product preferably food or feed product more particularly, meat analogues.

### SUMMARY

The present disclosure provides materials and methods that effect means of imparting specific thermal triggered release, for example during cooking of the product.

In addition, the present disclosure provides for the use of the powdered composition of the disclosed herein to minimize flavor loss, improve flavor intensity, and bring new sensorial experience during food preparation and consumption. Moreover, this present disclosure provides benefits in high water activity applications (typically Aw>0.8) by reducing flavor oil mobility, minimizing flavor-food matrix interactions, and offering additional flavor protection.

A first object of the present disclosure is therefore a process for preparing a powdered composition, said process comprising the steps of:
(i) Dispersing a dispersed phase, into a continuous phase comprising a carrier and optionally an emulsifier to obtain an oil-in-water emulsion, at a temperature above the melting peak temperature of the dispersed phase;
wherein the dispersed phase comprises a lipid mixture comprising at least a plant-based fat and a flavor or perfume oil;
(ii) Drying the emulsion of step (i) to obtain a powdered composition, at a temperature above the melting peak temperature of the dispersed phase, and
(iii) Cooling the powdered composition thus obtained to a temperature below the melting peak temperature of the dispersed phase.

A second object of the present disclosure is a powdered composition comprising:
a carrier,
optionally an emulsifier; and
a lipid mixture comprising at least a solid plant-based fat and a flavor or a perfume oil, wherein the lipid mixture and/or the powdered composition has

20° C.<Tₘ<70° C.

15° C.<T_{50%}<60° C.

20° C.<T_{95%}<80° C.
Tₘ represents melting peak temperature;
T_{50%} represents the temperature at which 50% by weight of solid plant-based fat melts;
T_{95%} represents the temperature at which 95% by weight of solid plant-based fat melts.

A third object of the present disclosure is a food, pet-food or feed product comprising the powdered composition as defined above, wherein the lipid mixture comprises at least a plant-based fat and a flavor oil, preferably said product comprises 0.01 to 10 wt % of the powdered composition, wherein the product is preferably in the form of a meat- and/or fish-based food or analogue.

### BRIEF DESCRIPTION OF THE DRAWINGS

FIG. 1 represents the melting profile of Sample C.

FIG. 2 represents the melting profile of sample D.

FIG. 3A represents the TGA analysis of the dispersed phase for Sample C at 50° C.

FIG. 3B represents the TGA analysis of the dispersed phase for Sample C at 60° C.

FIG. 4A represents the TGA analysis of the dispersed phase for Sample D at 50° C.

FIG. 4B represents the TGA analysis of the dispersed phase for Sample D at 60° C.

FIG. 5 represents volatile intensity via APCI-MS measurement during cooking of prepared burgers (samples A and C).

FIG. 6 represents volatile intensity via In-Nose measurement during eating of prepared burgers (samples A and C).

FIG. 7 represents a melting profile of Sample I analyzed by DSC after reconstitution of extruded powder.

FIG. 8 represents a melting profile of Sample J analyzed by DSC after reconstitution of extruded powder

### DETAILED DESCRIPTION OF THE PREFERRED EMBODIMENTS

Unless stated otherwise, percentages (%) are meant to designate a percentage by weight of a composition.

It should be understood that the total amount of ingredients in the composition or emulsion is 100%.

Unless specified otherwise, numerical ranges expressed in the format “from x to y” are understood to include x and y. When for a specific feature multiple preferred ranges are described in the format “from x to y”, it is understood that all ranges combining the different endpoints are also contemplated.

The term “comprise” or “comprising”, for the purpose of the present disclosure is intended to mean “including”. It is not intended to mean, “consisting only of”.

The following definitions and embodiments described below apply for all of the objects of the disclosure.

The term “fat” used in the present disclosure refers to lipid components that are solid or in the form of a paste at room temperature whereas the term “oil” used in the present disclosure refers to lipid components that are liquid at room temperature.

The term “emulsion”, as used herein, denotes a mixture of two or more liquids that are normally immiscible (i.e. not mixable). In an emulsion, one liquid (the dispersed phase) is dispersed in the other (the continuous phase). In the present disclosure, it is described an oil-in water emulsions comprising a continuous hydrophilic phase comprising water, in which the hydrophobic phase is dispersed.

The melting profile can be measured by differential scanning calorimeter Q2000 (TA Instruments, New Castle, DE, USA). Typically, small samples (5˜10 mg) are sealed in hermetic aluminum pans (Tzero, T161003). Typically, the program consists of the following steps: equilibrate at −20° C. for 5 minutes, ramp to 100° C. at 10° C./min, cooling to −20° C., hold isothermal at −20° C. for 5 min and ramp to 100° C. at 10° C./min. The instrument was calibrated for the melting temperature and enthalpy of fusion of Indium (Standard Reference Material 2232, National Institute of Standards and Technology, Gaithersburg, MD). DSC is widely used to determine percent of fat melted at a certain temperature. This technique is based on measuring the heat of fusion successively at different temperatures. The melting peak temperature and enthalpy of fusion can be obtained using “integrate peak linear” for each DSC curve. The melting peak temperature is the peak temperature of the phase transition curve via DSC. By reference to the total melting heat, the fraction of fat melted is determined. The method is described in “Cassel RB. Determining percent solid in an edible fat. TA Instruments Applications Brief TA290. 2002”. The melting profile is taken from the first heating ramp (scan) of the DSC curve at 10° C./min. The percentage of the solid lipid melted as a function of temperature can be calculated using ‘running integral’. Tₘ represents melting peak temperature, T_{50%} represents the temperature at which 50% by weight of solid lipid melts, T_{95%} represents the temperature at which 95% by weight of solid lipid melts.

In case of combination of more than two components, the melting profile of the mixture can be obtained by the same method as described previously.

By “melting temperature T_{50%}”, it is meant the temperature at which 50% by weight of plant-based fat melts.

By “melting temperature T_{95%}”, it is meant the temperature at which 95% by weight of plant-based fat melts.

Tₘ, T_{50%} and T_{95%} are well-known parameters used by the skilled person in the art. It can be easily determined by DSC (Differential Scanning Calorimetry) as described above.

By “plant-based fat”, it is meant a compound chosen in the group consisting of glycerides, fatty acids, hydrogenated oils that derived from plants.

By “flavor oil” it is meant here a flavoring ingredient or a mixture of flavoring ingredients.

By “perfume oil” it is meant here a perfuming ingredient or a mixture of perfuming ingredients.

“Emulsifiers” are amphiphilic molecules that concentrate at the interface between two phases and modify the properties of that interface. Examples of emulsifiers can be found in McCutcheon's Emulsifiers & Detergents or the Industrial Surfactants Handbook.

### Process for Preparing a Powdered Composition

A first object of the present disclosure is a process for preparing a powdered composition, said process comprising the steps of:
(i) Dispersing a dispersed phase, into a continuous phase comprising a carrier and optionally an emulsifier to obtain an oil-in-water emulsion, at a temperature above the melting peak temperature of the dispersed phase; wherein the dispersed phase comprises a lipid mixture comprising at least a plant-based fat and a flavor or perfume oil;
(ii) Drying the emulsion of step (i) to obtain a powdered composition, at a temperature above the melting peak temperature of the dispersed phase, and
(iii) Cooling the powdered composition thus obtained to a temperature below the melting peak temperature of the dispersed phase.

According to an embodiment, the lipid mixture consists of at least a plant-based fat and a flavor or perfume oil.

According to an embodiment, the dispersed phase consists of a lipid mixture comprising, preferably consisting of at least a plant-based fat and a flavor or perfume oil.

In step i) of the process of the present disclosure, a lipid mixture (i.e. dispersed phase) comprising at least a plant-based fat and a flavor or a perfume oil is dispersed into a continuous phase comprising a carrier and optionally an emulsifier. One of the essential features in step i) is that it is performed at a temperature above the melting peak temperature of the dispersed phase. In other words, the plant-based fat is in a liquid state in step i). Indeed, the fat, initially in a solid state or in a paste state at room temperature is fully melted in step i).

To that end, the fat can be heated separately to obtain the fat in its liquid state and then incorporated to the flavor oil to obtain a lipid mixture. Alternatively, the whole lipid mixture (i.e. comprising the plant-based fat and the flavor oil) can be added into the continuous phase comprising the carrier and optionally the emulsifier. The mixture of the two phases is heated to the temperature above the melting peak temperature of the dispersed phase.

According to an embodiment, in step i), the melting peak temperature of the dispersed phase (lipid mixture) is comprised between 20° C. and 80° C., preferably between 20° C. and 60° C., wherein the melting peak temperature is determined by DSC at a heating rate of 10° C./min.

Plant-based fat: According to a particular embodiment, the plant-based fat is chosen in the group consisting of palm fat, shea butter, algae butter, mono-/di-glycerides, palmitic acid, stearic acid, lauric acid, hydrogenated vegetable oil, palm stearin, shea stearin, rice stearin, sunflower stearin, and mixtures thereof. According to a particular embodiment, the plant-based fat is not a wax.

Flavor oil: By “flavor oil” it is meant here a flavoring ingredient or a mixture of flavoring ingredients, solvents or adjuvants used or the preparation of a flavoring formulation, i.e. a particular mixture of ingredients which is intended to be added to an edible composition (including but not limited to a beverage) or chewable product to impart, improve or modify its organoleptic properties, in particular its flavor and/or taste. The flavor oil is a liquid at about 20° C. Flavoring ingredient is understood to define a variety of flavor and fragrance materials of both natural and synthetic origins, including single compounds or mixtures. Many of these flavoring ingredients are listed in reference texts such as in the book by S. Arctander, Perfume and Flavour Chemicals, 1969, Montclair, N.J., USA, or its more recent versions, or in other works of similar nature such as Fenaroli's Handbook of Flavour Ingredients, 1975, CRC Press or Synthetic Food Adjuncts, 1947, by M. B. Jacobs, van Nostrand Co., Inc. Solvents and adjuvants of current use for the preparation of a flavoring formulation are also well known in the industry. These substances are well known to the person skilled in the art of flavoring and/or aromatizing foods and consumer products.

The flavoring ingredient may be a taste modifier or a taste compound.

Examples of taste compounds are salt, inorganic salts, organic acids, sugars, amino acids and their salts, ribonucleotides, and sources thereof.

A “taste modifier” is understood as an active ingredient that operates on a consumer's taste receptors, or provides a sensory characteristic related to mouthfeel (such as body, roundness, or mouthcoating) to a product being consumed. Non-limiting examples of taste modifiers include active ingredients that enhance, modify or impart saltiness, fattiness, umami, kokumi, heat sensation or cooling sensation, sweetness, acidity, tingling, bitterness or sourness.

Perfume oil: By “perfume oil” (or also “perfume”) what is meant here is an ingredient or composition that is a liquid at about 20° C. According to any one of the above embodiments said perfume oil can be a perfuming ingredient alone or a mixture of ingredients in the form of a perfuming composition. As a “perfuming ingredient” it is meant here a compound, which is used for the primary purpose of conferring or modulating an odor. In other words such an ingredient, to be considered as being a perfuming one, must be recognized by a person skilled in the art as being able to at least impart or modify in a positive or pleasant way the odor of a composition, and not just as having an odor. For the purpose of the present disclosure, perfume oil also includes combination of perfuming ingredients with substances which together improve, enhance or modify the delivery of the perfuming ingredients, such as perfume precursors, emulsions or dispersions, as well as combinations which impart an additional benefit beyond that of modifying or imparting an odor, such as long-lasting, blooming, malodor counteraction, antimicrobial effect, microbial stability, insect control.

The nature and type of the perfuming ingredients present in the oil phase do not warrant a more detailed description here, which in any case would not be exhaustive, the skilled person being able to select them on the basis of its general knowledge and according to intended use or application and the desired organoleptic effect. In general terms, these perfuming ingredients belong to chemical classes as varied as alcohols, aldehydes, ketones, esters, ethers, acetates, nitriles, terpenoids, nitrogenous or sulfurous heterocyclic compounds and essential oils, and said perfuming co-ingredients can be of natural or synthetic origin. Many of these co-ingredients are in any case listed in reference texts such as the book by S. Arctander, Perfume and Flavor Chemicals, 1969, Montclair, New Jersey, USA, or its more recent versions, or in other works of a similar nature, as well as in the abundant patent literature in the field of perfumery. It is also understood that said ingredients may also be compounds known to release in a controlled manner various types of perfuming compounds.

The perfuming ingredients may be dissolved in a solvent of current use in the perfume industry. The solvent is preferably not an alcohol. Examples of such solvents are diethyl phthalate, isopropyl myristate, Abalyn® (rosin resins, available from Eastman), benzyl benzoate, ethyl citrate, limonene or other terpenes, or isoparaffins. Preferably, the solvent is very hydrophobic and highly sterically hindered, like for example Abalyn® or benzyl benzoate. Preferably the perfume comprises less than 30% of solvent. More preferably the perfume comprises less than 20% and even more preferably less than 10% of solvent, all these percentages being defined by weight relative to the total weight of the perfume. Most preferably, the perfume is essentially free of solvent.

According to a particular embodiment, the lipid mixture comprises at least a plant-based fat and a flavor oil.

According to a particular embodiment, the ratio between the plant-based fat and the flavor or perfume oil is comprised between 5:95 to 95:5, particularly between 15:85 and 70:30, more particularly between 20:80 and 50:50.

According to a particular embodiment, the lipid mixture is present in an amount between 2.5 and 25%, preferably between 5 and 10%, the percentages being defined by weight, relative to the total weight of the emulsion.

Carrier: The carrier used in the present disclosure is preferably water soluble. A “water soluble carrier” is intended for the purpose of the present disclosure as encompassing any carrier which forms a one-phase solution in water. Preferably, it forms a one phase solution when dissolved in water at concentrations as high as 20% by weight, more preferably even as high as 50% by weight. Most preferably it forms a one phase solution when dissolved in water at any concentration. As non-limiting examples, maltodextrin, inulin, plant-based proteins such as pea protein, soluble flours, gums such as Gum Arabic, soluble fibers, soluble polysaccharides, and mixtures thereof can be used as carrier.

The term “soluble fiber” as used herein refers to polysaccharides characterized as being soluble by using the official method of the Association of Official Analytical Chemists (Prosky et al, 1988; J. Assoc. Of Anal. Chem, 70, 5, 1017), e.g. water soluble fibers, e.g. water soluble at room temperature. Said soluble fiber may be for example fruit fiber, grain fibers, natural soluble fibers and synthetic soluble fibers. Natural fibers include Soluble Corn Fiber, maltodextrin, acacia and hydrolyzed guar gum. Synthetic soluble fibers include polydextrose, modified food starch, and similar. Food grade sources of soluble fiber useful in embodiments of the present disclosure include inulin, corn fiber, barley, corn germ, ground oat hulls, milled corn bran, derivatives of the aleurone layer of wheat bran, flax flour, whole flaxseed bran, winter barley flake, ground course kilned oat groats, maize, pea fiber (e.g. Canadian yellow pea) Danish potatoes, konjac vegetable fiber, psyllium fiber from seed husks of planago ovate, psyllium husk, liquid agave fiber, rice bran, oat sprout fibers, amaranth sprout, lentil flour, grape seed fiber, apple, blueberry, cranberry, fig fibers, ciranda power, carob powder, milled prune fiber, mango fiber, apple fiber, orange, orange pulp, strawberry, carrageenan hydrocolloid, derivatives of eucheuma cottonnil seaweed, cottonseed, soya, kiwi, acacia gum fiber, bamboo, chia, potato, potato starch, pectin (carbohydrate) fiber, hydrolyzed guar gum, carrot, soy, soybean, chicory root, oat, wheat, tomato, polydextrose fiber, refined corn starch syrup, isomalto-oligosaccharide mixtures, soluble dextrin, mixtures of citrus bioflavonoids, cell-wall broken nutritional yeast, lipophilic fibers, plum juice, derivatives from larch trees, olygose fibers, derivatives from cane sugar, short-chain fructooligosaccharides, synthetic polymers of glucose, polydextrose, pectin, polanion compounds, cellulose fibers, cellulose fibers derived from hard wood plants and carboxymethyl cellulose.

According to a particular embodiment, the carrier has emulsifying properties such as Gum Arabic.

In this particular embodiment, the emulsifier is optional.

According to a particular embodiment, the carrier is present in an amount between 2.5 and 40%, preferably between 30 and 40%, the percentages being defined by weight, relative to the total weight of the emulsion.

Emulsifier: According to an embodiment, the emulsifier is needed to form oil-in-water emulsion. Hydrophilic emulsifiers are preferred to form and stabilize oil-in-water emulsions. Both polymeric emulsifiers and small molecule surfactants can be used. According to a particular embodiment, the emulsifier is selected in the group consisting of plant-based proteins such as pea protein and rice protein, gum Arabic, modified food starch, Quillaja saponins, lecithin, and mixtures thereof.

According to a particular embodiment, the emulsifier is present in an amount between 2.5 and 45%, preferably between 4 and 10%, the percentages being defined by weight, relative to the total weight of the emulsion.

In step i), the lipid mixture is dispersed into the continuous phase to obtain an emulsion. The emulsion can be formed using any known emulsifying method, such as high shear mixing, sonication or homogenization. Such emulsifying methods are well known to the person skilled in the art.

Advantageously, the emulsion presents a drop size having an average diameter (d₅₀) of between 0.1 to 20 microns, preferably 0.8 to 20 microns, most preferably 1 to 10 microns.

The drop size can be measured via any well-established method that allows measurements which are accurate within an experimental error of 5% at the most and preferably below 1%. Suitable well established methods use laser diffraction particle size analyser (e.g. Coulter LS 13 320 from Beckman Coulter, Brea, CA, USA). Upon analysis the volume statistics (d_{4,3}) was determined to characterize the emulsion.

In step ii) of the process, the mixture of step (i) is dried to obtain a powdered composition, at a temperature above the melting peak temperature of the dispersed phase (i.e. the lipid mixture).

The powdered composition may be prepared by any suitable method readily selected by one of ordinary skill in the art. Non-limiting examples of methods include extrusion, spray drying, and the like.

According to a particular embodiment, the mixture in step ii) is dried by spray-drying.

The emulsion can be first subjected to a spraying step during which the emulsion is dispersed in the form of drops into a spraying tower. Any device capable of dispersing the emulsion in the form of drops can be used to carry out such dispersion. For instance, the emulsion can be guided through a spraying nozzle or through a centrifugal wheel disk. Vibrated orifices may also be used.

In one aspect of the disclosure the emulsion is dispersed in the form of drops into a cloud of powdering agent present in the dry tower. Such type of process is for example described in details in WO2007/054853 or in WO2007/135583.

For a specific formulation, the size of the granules obtained by spray-drying is influenced by the size of the drops that are dispersed into the tower. When a spraying nozzle is used for dispersing the drops, the size of such drops can be controlled by the flow rate of an atomising gas through the nozzle, for example. In the case where a centrifugal wheel disk is used for dispersal, the main factor for adjusting droplet size is the centrifugal force with which the drops are dispersed from the disk into the tower. The centrifugal force, in turn, depends on the speed of rotation and the diameter of the disk. The feed flow rate of the emulsion, its surface tension and its viscosity are also parameters controlling the final drop size and size distribution. By adjusting these parameters, the skilled person can control the size of the drops of the emulsion to be dispersed in the tower.

Once sprayed in the chamber, the droplets are dried using any technique known in the art. These methods are perfectly documented in the patent and non-patent literature in the art of spray-drying. For example, Spray-Drying Handbook, 3^{rd} ed., K. Masters; John Wiley (1979), describes a wide variety of spray-drying methods.

The process of the present disclosure may be performed in any conventional spraying tower. A conventional multi-stage drying apparatus is for example appropriate for conducting the steps of this process. It may comprise a spraying tower, and, at the bottom of the tower, a fluidised bed intercepting partially dried granules after falling through the tower.

In step iii) of the process, the powdered composition thus obtained is cooled to a temperature below the melting peak temperature of the lipid mixture, typically at a temperature comprised between 4° C. and 50° C., more particularly between 10° C. and 50° C.

Another object of the disclosure is a powdered composition obtainable by the process as defined above.

### Powdered Composition

Another object of the disclosure is a powdered composition comprising:
a carrier,
optionally an emulsifier; and
a lipid mixture comprising at least a solid plant-based fat and a flavor or perfume oil, wherein the lipid mixture and/or the powdered composition has

20° C.<Tₘ<70° C.; and

15° C.<T_{50%}<60° C.; and

20° C.<T_{95%}<80° C.
Tₘ represents melting peak temperature;
T_{50%} represents the temperature at which 50% by weight of solid plant-based fat melts;
T_{95%} represents the temperature at which 95% by weight of solid plant-based fat melts.

According to the disclosure, Tₘ, T_{50%} and T_{95%} are determined by DSC at a heating rate of 10° C./min.

According to a particular embodiment, the lipid mixture and/or the powdered composition has:

20° C.<Tₘ<60° C.; and

20° C.<T_{50%}<55° C.; and

25° C.<T_{95%}<70° C.

According to a particular embodiment, the lipid mixture is present in an amount between 5 and 50%, preferably between 10 and 20%, the percentages being defined by weight, relative to the total weight of the composition.

According to a particular embodiment, the emulsifier is present in an amount between 5 and 95%, preferably between 8 and 20%, the percentages being defined by weight, relative to the total weight of the composition.

According to a particular embodiment, the carrier is present in an amount between 5 and 95%, preferably between 60 and 80%, the percentages being defined by weight, relative to the total weight of the composition.

The powdered composition of the disclosure may also comprise residual amounts of water, but typically less than 15%, preferably less than 10%, more preferably less than 5% by weight, relative to the total weight of the composition.

According to an embodiment, the powdered composition is in the form of granules, preferably spray-dried granules.

In a preferred aspect of the disclosure the size of the granules is typically of at least 10 μm, preferably at least 20 μm. Depending on the process used for spray-drying, in particular when a powdering agent is present in the drying tower, as described above, the dry granules can have an average size of up to 200 or even up to 750 μm. In a preferred embodiment of the disclosure, the average size of the granules is at least 5 times larger than the average size of the oil droplets in the emulsion.

### A Food, Pet-Food or Feed Product Comprising the Powdered Composition

The powdered composition of the disclosure can be used in a great variety of edible end products. The present disclosure is particularly suitable for end products where thermal treatment is applied during food preparation and/or consumption. Indeed, below melting peak temperature, the lipid mixture behaves more like a semi-solid, oil mobility decreases, and oil release is suppressed; whereas above melting peak temperature (typically during cooking), the lipid mixture behaves more like a liquid, oil mobility increases, and oil release is enhanced.

End products are more particularly a food, pet-food or feed products. The powdered composition of the disclosure is particularly advantageous for vegetarian meat analogues or meat replacers, vegetarian burger, sausages, patties, chicken-imitate nuggets . . . , meat products (e.g. processed meat, poultry, beef, pork, ham, fresh sausage or raw meat preparations, spiced or marinated fresh meat or cured meat products, reformed meat) or extended meat products making use of a combination of animal and vegetable protein in varying ratios, often being coextruded or a mix between textured vegetable protein and animal protein.

Meat, for the purpose of the present disclosure, encompasses red meat, such as beef, pork, sheep, lamb, game and poultry, such as chicken, turkey, goose and duck. Preferably, the food of the present disclosure is meat selected from beef, poultry and pork.

Nevertheless, and due to its resistance to shearing and high temperatures, the powdered composition of the disclosure can also be of particular interest in the following examples of products:
Baked goods (e.g. bread, dry biscuits, cakes, other baked goods),
Cereal products (e.g. breakfast cereals, pre-cooked ready-made rice products, rice flour products, millet and sorghum products, raw or pre-cooked noodles and pasta products),
Milk products (e.g. fresh cheese, soft cheese, hard cheese, milk drinks, whey, butter, partially or wholly hydrolysed milk protein-containing products, fermented milk products, condensed milk and analogues),
Dairy based products (e.g. fruit or flavored yoghurt, ice cream, fruit ices, frozen desserts)
Dairy analogues (imitation dairy products) containing non-dairy ingredients (plant-based proteins, vegetable fats),
Confectionary products (e.g. chewing gum, hard and soft candy),
Chocolate and compound coatings,
Products based on fat and oil or emulsions thereof (e.g. mayonnaise, spreads, margarines, shortenings, remoulade, dressings, spice preparations),
Spiced, marinated or processed fish products (e.g. fish sausage, surimi),
Eggs or egg products (dried egg, egg white, egg yolk, custard),
Desserts (e.g. gelatins and puddings),
Products made of soya protein or other soya bean fractions (e.g. soya milk and products made therefrom, soya lecithin-containing preparations, fermented products such as tofu or tempeh or products manufactured therefrom, soya sauces),
Vegetable preparations (e.g. ketchup, sauces, processed and reconstituted vegetables, dried vegetables, deep frozen vegetables, pre-cooked vegetables, vegetables pickled in vinegar, vegetable concentrates or pastes, cooked vegetables, potato preparations),
Spices or spice preparations (e.g. mustard preparations, horseradish preparations), spice mixtures and, in particular seasonings which are used, for example, in the field of snacks.
Snack articles (e.g. baked or fried potato crisps or potato dough products, bread dough products, extrudates based on maize, rice or ground nuts),
Ready dishes (e.g. instant noodles, rice, pasta, pizza, tortillas, wraps) and soups and broths (e.g. stock, savory cube, dried soups, instant soups, pre-cooked soups, retorted soups), sauces (instant sauces, dried sauces, ready-made sauces, gravies, sweet sauces).
Extended meat products (e.g. meat patties, sausages, chili, salisbury steaks, pizza toppings, meatballs, ground meat, bolognas, chicken nuggets, pork frankfurters, beef)

The disclosure is particularly advantageous in that the food product will need the addition of less flavor for a same organoleptic perception.

According to one embodiment, the food, pet-food or feed product comprises between 0.01 and 10% by weight, preferably between 0.1 and 5% by weight of the powdered composition of the disclosure.

Typically the food, pet-food or feed product further comprises proteins notably vegetable proteins or animal proteins, and mixtures thereof.

Advantageously the vegetable proteins are preferably selected among soy protein, corn, peas, canola, sunflowers, sorghum, rice, amaranth, potato, tapioca, arrowroot, chickpeas, lupins, canola, wheat, oats, rye, barley, and mixtures thereof.

The powdered composition of the disclosure is particularly suitable for extruded and/or baked food, pet-food or feed products more particularly comprising animal and/or vegetable proteins. Typically, said extruded and/or baked food, pet-food or feed products may be selected among meat- and/or fish-based food or analogue and mixtures thereof (in other words, meat-based food and/or fish-based food or meat analogue or fish analogue and mixtures thereof); extruded and/or baked meat analogue or extruded and/or baked fish analogue are preferred. Non-limiting examples of extruded and/or baked food, pet-food or feed products are snack products or extruded vegetable proteins with the aim to texture the protein from which meat analogous (e.g. burgers) are prepared from. The powdered composition can be added pre-extrusion or after extrusion to either, the non-extruded vegetable protein isolate/concentrate or to the textured vegetable protein from which a burger or nugget (etc.) is formed.

### Method for Improving the Organoleptic Properties of a Food, Pet-Food or Feed Product

The disclosure further concerns a method for improving the organoleptic properties of a food, pet-food or feed product, comprising the step of adding 0.01 to 10 wt %, preferably, 0.1 to 10 wt % or 0.5 to 5 wt % of the powdered composition of the disclosure to the food, pet-food or feed product.

Advantageously, the food, pet-food or feed product is a meat analogues or meat replacers, vegetarian burger, sausages, patties, chicken-imitate nuggets . . . , meat products (e.g. processed meat, poultry, beef, pork, ham, fresh sausage or raw meat preparations, spiced or marinated fresh meat or cured meat products, reformed meat).

Advantageously, the food, pet-food or feed product is a fish-based food or analogue.

Typically, the powdered composition is added to the food, pet-food or feed product by injection, vacuum tumbling optionally with a carrier material or mixing with the food prior to its preparation by extrusion.

The disclosure further concerns a method for improving the aroma, juiciness, and/or mouthfeel of a meat- and/or fish-based food or analogue, the method comprising the step of adding the powdered composition of the disclosure to the meat- and/or fish-based food or analogue.

According to the disclosure, the expression “improving the juiciness” refers to the improvement of the sensory attributes of juiciness.

### A Method for Reducing or Replacing Fat in Food, Pet-Food or Feed Products and the Food, Pet-Food or Feed Products Obtained

The disclosure further concerns a food, pet-food or feed products formulation having a reduced level of fat and/or oil typically, animal fat and/or oil comprising the powdered composition of the disclosure.

The disclosure also concerns the use of the powdered composition as a fat replacer typically an animal fat replacer in food, pet-food or feed products.

The disclosure also concerns a method for preparing a food, pet-food or feed products having a reduced amount of fat typically, animal fat, which comprises the step of adding the powdered composition of the disclosure to the food, pet-food or feed products and thus partially or totally replacing fat.

The disclosure also concerns a method for reducing or replacing fat typically, animal fat in food, pet-food or feed products, said method comprises the step of replacing a portion or the totality of fat by the powdered composition of the disclosure.

The disclosure also concerns a flavor delivery system comprising the powdered composition of the disclosure and the use of the powdered composition as a flavor delivery system in food, pet-food or feed products.

According to the disclosure, a flavor delivery system refers to a system able to release a flavor.

The disclosure is particularly advantageous in sauces such as pasta sauces, in soups, marinades and/or pastes notably used for fish or meat products, in confectionery products and dairy products.

The disclosure also concerns the use of the powdered composition to impart desired textural attributes, to improve the texture of a food, pet-food or feed product, such as juiciness, mouthfeel, thickness or mouthcoating.

The present disclosure will now be illustrated in greater detail by way of the following examples, but it should be understood that the disclosure is not construed as being limited thereto.

### EXAMPLES

### Protocols and Methods

Melting profile analysis via differential scanning calorimetry (DSC) The melting behavior measurements were conducted on a differential scanning calorimeter Q2000 (TA Instruments, New Castle, DE, USA). For dispersed phase (mixture of plant-based fat and liquid flavor oil), small samples (5˜10 mg) were sealed in hermetic aluminum pans (Tzero, T161003). The program consisted of the following steps: equilibrate at −20° C. for 5 minutes, ramp to 100° C. at 10° C./min, cooling to −20° C., hold isothermal at −20° C. for 5 min and ramp to 100° C. at 10° C./min. For spray dried powders, the samples were reconstituted with de-ionized water at 10-40% solids content and then small sample (5˜10 mg) of the reconstituted powders was sealed in hermetic aluminum pans. The program consisted of the following steps: equilibrate at 5 or 10° C. for 5 minutes, ramp to 90° C. at 10° C./min, cooling to 5 or 10° C., hold isothermal at 5 or 10° C. for 5 min and ramp to 90° C. at 10° C./min. The instrument was calibrated for the melting temperature and enthalpy of fusion of Indium (Standard Reference Material 2232, National Institute of Standards and Technology, Gaithersburg, MD). DSC is widely used to determine percent of fat melted at a certain temperature. This technique is based on measuring the heat of fusion successively at different temperatures. The melting peak temperature and enthalpy of fusion can be obtained using “integrate peak linear” for each DSC curve. The melting peak temperature is the peak temperature of the phase transition curve via DSC. By reference to the total melting heat, the fraction of fat melted is determined. The method can be found in “Cassel RB. Determining percent solid in an edible fat. TA Instruments Applications Brief TA290. 2002”. The melting profile was taken from the first heating ramp (scan) of the DSC curve. The percentage of the solid lipid melted as a function of temperature can be calculated using ‘running integral’. Tₘ represents melting peak temperature; T_{50%} represents the temperature at which 50% by weight of solid lipid melts; T_{95%} represents the temperature at which 95% by weight of solid lipid melts. All samples were measured in duplicate.

### Thermal Triggered Release Via Thermogravimetric Analysis (TGA)

Thermogravimetric analyzer (Q50, TA Instruments, New Castle, DE, USA) was used to study the thermal stability and flavor release of prepared samples. A small sample (˜20 mg) of the mixture of plant-based fat and beef flavor oil was placed in a hermetic aluminum pan (Tzero, T161003). The heating program consisted of the following steps: equilibrate at 30° C., ramp to 50 or 60° C. at 10° C./min, hold isotherm at 50 or 60° C. for an hour. All samples were measured in duplicate. The normalized ratio was obtained from the calculation using the following equation:

Normalized ratio=weight loss rate of the mixture of beef flavor oil and plant-based fat /weight loss rate of beef flavor oil without plant-based fat

### Oil Content Measurement by TD-NMR

Time-domain nuclear magnetic resonance (TD-NMR, Minispec mq20, Bruker, Billerica, USA) was used for the oil content measurement as described in previous study (Hafner, Dardelle, Normand, & Fieber, Eur. J. Lipid Sci. Technol., 2011, 113, 7, 856-861). A calibration curve of flavor oil was created using neat flavor oil at five different concentrations. It should be mentioned that NMR measures the content of oil in liquid state whereas lipid in solid state cannot be measured by NMR. Crystallization of plant-based fat in spray dried powder can be monitored via DSC analysis by comparing the melting enthalpy of fat in spray dried powder with theoretical melting enthalpy of known amount of fat in the powder. After fully crystallization of plant-based fat, spray dried powders were analyzed via NMR to obtain retained flavor oil content.

### Water Activity Measurement

Water activity (A_{w}) measurements were conducted in duplicate on all powder samples using a water activity meter (AquaLab Series 3TE, Decagon Devices Inc., Pullman, WA, USA). The water activity meter was calibrated using standards provided by the vendor (A_{w}=0.250) as well as distilled water.

### Example 1

### Preparation of the Dispersed Phase

Plant-derived solid lipids (palm stearin, mono-/di-glycerides, palmitic acid) are incorporated in liquid flavor oils to obtain structured oil with desirable melting behavior. A series of mixtures of representative solid lipids and beef flavor oil were prepared at different ratios. The lipid mixtures (fat and oil) were held in water bath at 85° C. for 10 min to ensure all fat is completely melted. All the samples were mixed thoroughly after melting to ensure the mixture is homogeneous. The mixtures were kept in the hot water bath for another 10 min followed by cooling in the water bath at room temperature to solidify the lipid mixtures.

Solidified lipid mixtures were analyzed by DSC to obtain the melting profile as shown in Table 1. The temperatures Tₘ, T_{50%}, and T_{95%}, all increase as the concentration of solid fat increased making the disclosure suitable for different kind of applications.

TABLE 1
Compositions of lipid mixtures made from different plant-derived solid fat

| Composition | Samples | | | | | | | | | | | | |
|---|---|---|---|---|---|---|---|---|---|---|---|---|---|
| (wt %) | #1 | #2 | #3 | #4 | #5 | #6 | #7 | #8 | #9 | #10 | #11 | #12 | #13 |
| Beef flavor | 75% | 70% | 65% | 60% | 90% | 80% | 70% | 65% | 90% | 85% | 80% | 75% | 70% |
| oil | | | | | | | | | | | | | |
| Palm stearin^{a} | 25% | 30% | 35% | 40% | | | | | | | | | |
| Mono-/di- | | | | | 10% | 20% | 30% | 35% | | | | | |
| glycerides^{b} | | | | | | | | | | | | | |
| Palmitic | | | | | | | | | 10% | 15% | 20% | 25% | 30% |
| acid^{c} | | | | | | | | | | | | | |
| Tₘ (° C.) | 49.3 | 51.6 | 52.8 | 53.9 | 45.4 | 51.3 | 54.6 | 59.2 | 24.7 | 29.0 | 32.7 | 35.6 | 41.0 |
| T_{50%} (° C.) | 47.2 | 49.3 | 50.9 | 51.8 | 44.4 | 50.9 | 52.6 | 55.0 | 19.2 | 24.8 | 28.1 | 32.4 | 36.1 |
| T_{95%} (° C.) | 54.3 | 54.6 | 59.6 | 57.0 | 53.2 | 60.1 | 60.2 | 63.1 | 27.1 | 32.5 | 37.0 | 42.0 | 44.9 |

^{a}Palm stearin, Palmes 63 from Fuji Vegetable Oil, Inc. Savannah, Georgia 31408, USA
^{b}Mono-/di-glycerides, also known as rapeseed glycerides from J&L Chemicals LTD
^{c}Palmitic acid, Firmenich

### Example 2

### Preparation of Powdered Composition According to the Disclosure

A box type dryer (Ernest D. Menold Inc., Lester, PA, USA) equipped with high pressure homogenizer and high pressure nozzle atomizer was used to produce spray dried beef flavor. The dryer has water evaporation capacity of 20 kg/hr. The batch size was 10 kg for all spray dried powders. First matrix materials (carrier) were dissolved in water in a steam-jacked kettle with a Lightnin® mixer. This matrix solution was mixed at 65° C. for 30 min to ensure fully hydration of materials. Then beef flavor oil or the homogenous, completely melted mixture of beef flavor and palm fat was added and mixed for 5 min to form a pre-emulsion. The resultant coarse emulsion was passed through a two-stage high pressure Gaulin M12 homogenizer from Manton-Gaulin Company (Boston, MA, USA) at 14 MPa (1st stage) and 1.4 MPa (2nd stage). Finally the homogenized emulsion was atomized at 7 MPa with inlet and outlet air temperatures of the dryer maintained at 180-190′C and 70-80*C, respectively. The spray dry formulation was presented in Table 2.

TABLE 2
Composition and melting profile of the spay-dried powdered composition

| | Samples | | | | | | | | | |
|---|---|---|---|---|---|---|---|---|---|---|
| Composition | Comparative A | | B | | C | | D | | E | |
| Palm stearin | | | 350 | g | 350 | g | | | | |
| (plant-based fat) | | | | | | | | | | |
| Mono-, Di-glycerides | | | | | | | 200 | g | | |
| (plant-based fat) | | | | | | | | | | |
| Palmitic acid | | | | | | | | | 250 | g |
| (plant-based fat) | | | | | | | | | | |
| Beef flavor | 1,000 | g | 650 | g | 650 | g | 800 | g | 750 | g |
| (liquid flavor oil) | | | | | | | | | | |
| Maltodextrin 18DE | 3,600 | g | | | 3,600 | g | 3,600 | g | 3,400 | g |
| (carrier) | | | | | | | | | | |
| Senegal Gum Arabic | 400 | g | | | 400 | g | | | | |
| (emulsifier) | | | | | | | | | | |
| Pea protein | | | 400 | g | | | 400 | g | 600 | g |
| Nutralys S85F | | | | | | | | | | |
| (emulsifier) | | | | | | | | | | |
| Inulin | | | 3,600 | g | | | | | | |
| Fibrulose ® F97 | | | | | | | | | | |
| (carrier) | | | | | | | | | | |
| Water | 5,000 | g | 5,000 | g | 5,000 | g | 5,000 | g | 5,000 | g |

| Oil content* | 10.2% | 9.2% | 9.9% | 10.0% | 9.5% |
|---|---|---|---|---|---|
| Powder water activity | 0.15 | 0.14 | 0.12 | 0.18 | 0.20 |
| (25° C.) | | | | | |
| **Tₘ | N/A | 52.3 | 52.0 | 47.0 | 43.0 |
| **T_{50%} | N/A | 49.7 | 48.4 | 48.1 | 37.7 |
| **T_{95%} | N/A | 58.6 | 57.3 | 53.2 | 51.5 |

*The oil contents of the spray dried powders were measured by LF-NMR after stored in the freezer for overnight and confirmed fully crystallization of fat in powder vis DSC;
**DSC measurements were conducted for the reconstituted spray dried powders (10% in water) after stored in the freezer for overnight.

### Example 3

### Thermal Characterization of the Powdered Composition According to the Disclosure

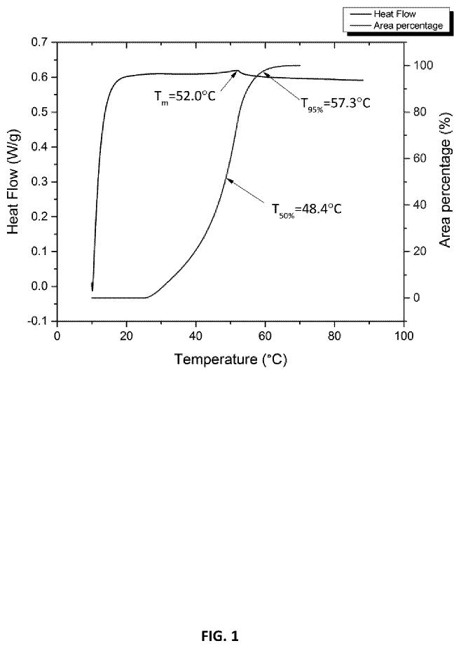

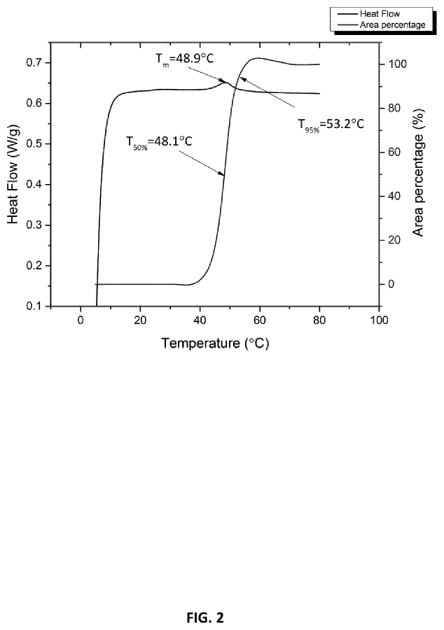

The prepared spray dried powders were reconstituted with water and analyzed by DSC as shown in FIG. 1 (Sample C) and FIG. 2 (Sample D).

The peaks on DSC graphs indicating melting of solid fat in spray dried powders. The Tₘ, T_{50%}, and T_{95%} of reconstituted powders were obtained from the DSC graph as described previously in protocol and methods.

Sample C and sample D were also analyzed by TGA.

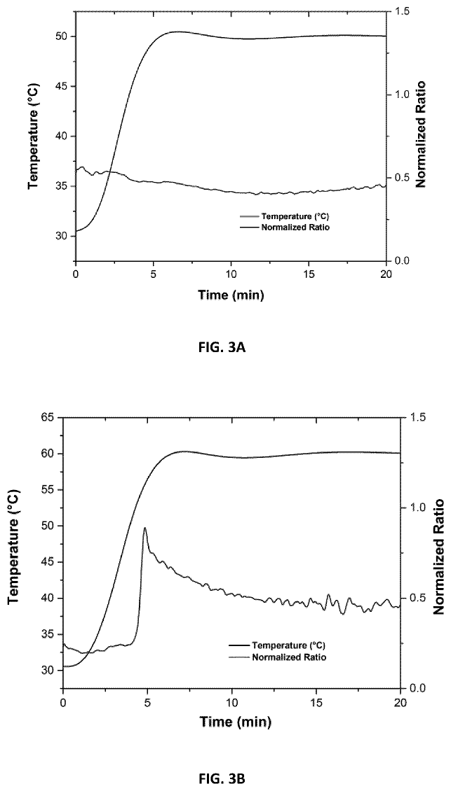

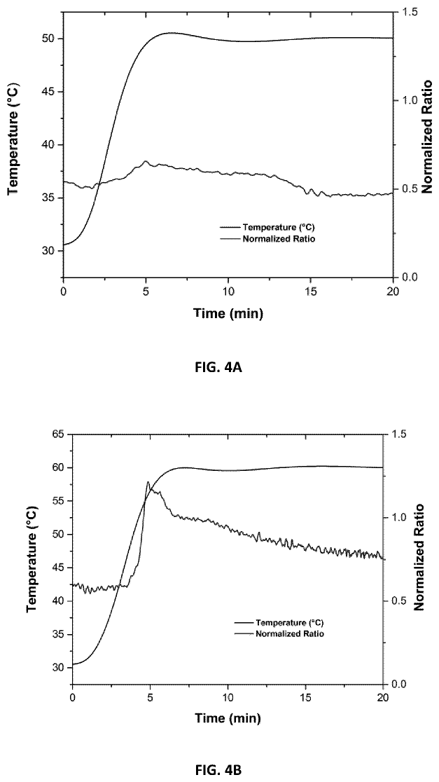

A control with neat beef flavor oil as also analyzed. The normalized ratio (weight loss rate of palm stearin-beef flavor mixture/weight loss rate of neat beef flavor) is presented in FIG. 3 and FIG. 4. When the solidified mixture is heated to 50° C., the normalized ratio showed relatively small changes; whereas there was abrupt increase at around 47° C. in normalized ratio when the solidified mixture is heated up to 60° C. This clearly demonstrated the temperature triggered release properties of structured mixture of mono-, di-glycerides and beef flavor oil. The transition temperature is around 47° C.

The enthalpies of fusion for the lipid mixture and the reconstituted spray dried powder were compared. As shown in the table 3, the enthalpy of fusion of a lipid mixture for Sample C′ (see composition below) largely agrees with that of reconstituted powder for Sample C. This indicates that palm stearin is fully crystallized in the spray dried powder at the similar extent as that in the lipid mixture.

TABLE 3
Enthalpy of fusion derived from DSC for the lipid mixture and
reconstituted spray dry powder containing the lipid mixture

| | | Enthalpy of fusion |
|---|---|---|
| | | (J/g palm stearin, |
| Samples | Description | n = 2) |
| Sample C′ | Lipid mixture containing 35% | 195 |
| | palm stearin and 65% beef flavor | |
| | solidified at room temperature | |
| Sample C | Spray dried powder | 189 |
| | containing lipid mixture | |
| | was reconstituted at 10% wt./wt. | |

### Example 4

### Performance of the Powdered Composition According to the Disclosure in a Vegan Burger Application

Comparative Sample A, samples B and C of the disclosure stored in cold box (˜4° C.) were used in vegan burger application (80/20 pea burger patties) at the same dosage of 0.05% beef flavor. Sensory evaluation (chew and split) was conducted with 7 trained panelists. The results were presented in Table 4.

TABLE 4
Sensory results in Vegan Burger application

| | dosage - | Aroma | Flavor | | |
|---|---|---|---|---|---|
| Sample Name | isoload | intensity* | intensity* | Liking* | Comments |
| Comparative | 0.05% | 3.3 | 3.0 | 3.0 | Aroma: green character |
| sample A | | | | | slight meaty, cereal, bready, corn, slight |
| | | | | | grilled, crispy, fatty, waxy, rancid, , fatty, |
| | | | | | meaty notes, lingering, oily, mouthfeel, |
| | | | | | cereal, juicy, bland, not meaty, weak |
| Sample B | | 3.9 | 3.9 | 4.0 | Aroma: meaty |
| | | | | | still bready, slight cardboard, astringent, |
| | | | | | less juicy, meaty, waxy, fatty, beef, oily, |
| | | | | | quite bland, cereal, juicy, salty, good |
| Sample C | | 4.3 | 4.3 | 4.3 | Aroma: meaty |
| | | | | | juicy, tallow, slight sweet, meaty, fatty, |
| | | | | | slight green notes, oily, quite neutral, |
| | | | | | slight roast, beef, less salty |

*a scale of 0-5 was used for intensity rating with zero as extremely low intensity and 5 as extremely high intensity.

Samples B and C containing the powdered composition according to the disclosure perform better than comparative Sample A without palm stearin in aroma intensity, flavor intensity and liking, which demonstrated that the powdered composition according to the disclosure brings sensorial benefits in the vegan burger application.
AFFIRM® (Analysis of Flavor and Fragrance in Real tiMe) Measurement

AFFIRM® was employed to determine the flavor release behavior of comparative sample A and Sample C. 50 g of pea burgers were placed on a hotplate at 180° C., covered with a glass bowl fitted with two glass ports (one for the introduction of the air and one for the connection to the instrument). Each burger was cooked for 3 minutes on each side.

APCI-MS (Atmospheric Pressure Chemical Ionization-Mass Spectrometry) was used to analyze the flavor delivery during cooking by measuring the headspace concentration of un-flavored and flavored burgers.

The sampled air containing the volatiles released during cooking is drawn into a Mass Spectrometer. Volatiles are then ionized in the ionization chamber with H3O+ ions. The volatiles present in the headspace during cooking are sampled via APCI-MS for 6 minutes. Analyses are done in triplicates. Parameters of APCI-MS are described in Table 5.

TABLE 5
Instrument parameters of AFFIRM ® analysis

| Instrument | WATERS SQD-2 | |
|---|---|---|
| Flow Rate | 8 | ml/min |
| Sample Transfer line | 150° | C. |
| Carrier Gas Transfer line | 105° | C. |
| Source Temperature | 105° | C. |
| Dilution gas (air) (I) | 250 | ml/min |
| Dilution gas (air) (II) | 200 | ml/min |
| Hotplate Temperature | 180° | C. |
| Measurement Time | 6 | Minutes |

### In-Nose Measurements

Panelists were asked to consume 5 g of the pea protein burger while connected via the nose to the AFFIRM® instrument. The air from the nose was sampled at a rate of 50 ml/min by the AFFIRM®. 1 replicate per panelist (3 panelists in total) for each sample was carried out.

### Data Processing

For the dynamic headspace measurements, the signal intensities for all non-flavored and flavored samples were processed by calculating Area Under the Peak for each signal.

The average of the three samples measured was calculated together with the standard deviation and error of the measurement.

For the nose-space measurements, the release curves for each volatile released from the pea burgers for all 3 panelists were averaged and the sum taken to give a total flavor release curve for each burger.

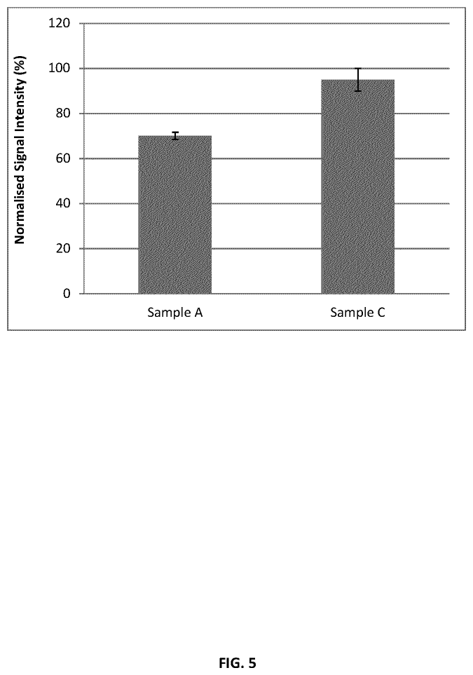

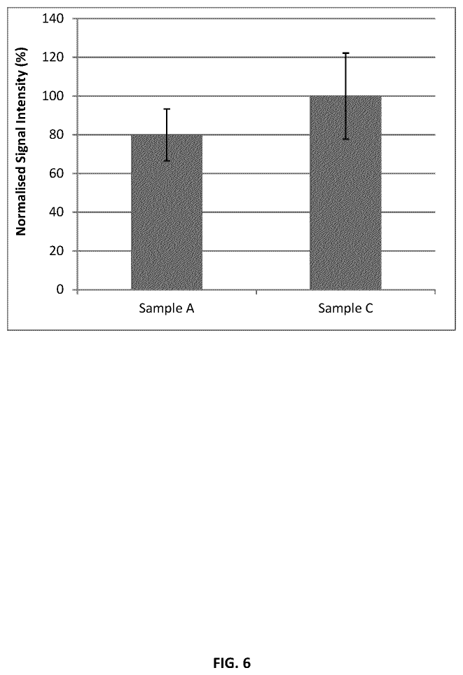

FIG. 5 shows the volatile intensity via APCI-MS measurement during cooking of prepared burgers and FIG. 6 shows the volatile intensity via In-Nose measurement during eating of prepared burgers. The headspace measurement during cooking and In-Nose measurement during eating indicated that Sample C outperformed Sample A at iso-dosage of beef flavor. Therefore, Sample C provides improved sensorial experience during both cooking and eating.

### Example 5

### Performance of the Powdered Composition According to the Disclosure in a High Protein Application

Spray dried powders were prepared with lemon flavor oil (Comparative sample F) and lipid mixture of palm stearin and lemon flavor oil (Sample G) according to the same protocol of Example 1. The spray dry formulation and physical properties of spray dried powders were presented in Table 6.

TABLE 6
Compositions of the spray dried structured Lemon flavor oil and
thermal properties of structured oil in the reconstituted powder

| | Examples | | | |
|---|---|---|---|---|
| Composition of feed emulsion | Comparative sample F | | Sample G | |
| Palm fat (Palmes63, Fuji oil USA) | | | 350 | g |
| Lemon flavor | 1,000 | g | 650 | g |
| Senegal Gum Arabic (Nexira USA) | 400 | g | 400 | g |
| Maltodextrin 18DE (Cargill USA) | 3,600 | g | 3,600 | g |
| Water | 5,000 | g | 5,000 | g |

| Oil content in powder* | 12.3% | 11.7% | |
|---|---|---|---|
| Powder water activity (25° C.) | 0.24 | 0.20 | |
| Tₘ | | 43.2° | C. |
| T_{50%} | | 39.2° | C. |
| T_{95%} | | 52.4° | C. |

*The oil contents of the spray dried powders were measured by LF-NMR after stored in the freezer for overnight;
**DSC measurements were conducted for the reconstituted spray dried powders (10% in water) after stored in the freezer for overnight;

Comparative sample F and Sample G according to the disclosure were stored in the cold box before the testing in high protein oatmeal application at the dosage of 0.05% lemon oil. The oatmeal formulation is:
Instant oats: 22 g
Sugar: 8 g
Flavor: 0.05%

### Panelist Protocol:

Panelist receives one sample at a time
Panelist is instructed to add hot water to the sample, put the lid on the cup, and wait one minute for oatmeal to cook before evaluation
Samples were presented in counterbalanced order and given random three-digit blinding codes

TABLE 7
Sensory results in high protein oatmeal application

| | | Attribute | | | | |
|---|---|---|---|---|---|---|
| Sample | dosage - | Lemon | Overall | Sweet- | Lemon | |
| Name | isoload | Aroma* | Aroma* | ness* | Flavor* | Cereal* |
| Comparative | 0.05% | 5.2 | 5.9 | 4.9 | 5.7 | 4.5 |
| sample F | | | | | | |
| Sample G | | 5.8 | 6.2 | 5.2 | 5.5 | 5.2 |

*a scale of 0-7 was used for intensity rating with zero as extremely low intensity and 7 as extremely high intensity.

Compared to Comparative sample F without palm stearin, Sample G according to the disclosure shows enhanced performance. This suggests spray dried structured lemon oil may bring sensorial benefits in high protein oat meal application.

### Example 6

### Preparation of Powdered Composition by Twin Screw Extrusion According to the Disclosure

Extruded particles were prepared on a co-rotating twin screw extruder BC21 (Clextral, Firminy, France) with screw diameter of D=25 mm and length to diameter ratio of L/D=32. The extruder consists of 8 barrels which are independently temperature controlled with a temperature profile of 20, 20, 20, 90, 90, 90, 90, 100° C. from feeding to die end. The melt was extruded through a die plate with 0.7 mm diameter of orifice. Strands exiting the die were pelletized by 2 rotating blades at a constant speed. After pelletization, particles were cooled by compressed air and pneumatically conveyed to a sample collector. Flavor oil and solid fats were pre-blended with maltodextrin and modified starch. The powder flow rate was 8.0 kg/h. Water was injected into the extruder with predetermined amount in order to obtain target glass transition temperature (T_{g}) of ˜40° C. The batch size was around 10 kg. Samples were collected after the extrusion process reached steady state. Three extruded samples were made: one control without solid fat and two samples with solid fats. These samples were analyzed by NMR and DSC to obtain oil content in extruded powders and melt profile of reconstituted extruded powders. The extrusion formula (dry basis) and characterization data are summarized in Table 8. It should be noted that the measured oil content is the content of oil in the liquid state. All extruded samples showed similar retained oil content.

TABLE 8
Composition and melting profile of
the extruded powder composition

| | Samples | | | |
|---|---|---|---|---|
| Composition | | H | I | J |

| | | | | | | |
|---|---|---|---|---|---|---|
| Palmitic acid | | | 160 | g | 200 | g |
| Beef flavor | 520 | g | 520 | g | 650 | g |
| Coconut oil | | | 120 | g | 150 | g |
| Tomato Powder | | | 1,000 | g | 1,000 | g |
| Modified starch | 928 | g | 800 | g | 780 | g |
| (Capsul ®) | | | | | | |
| Maltodextrain 9DE | 8,352 | g | 7,200 | g | 7,020 | g |
| DATEM | 200 | g | 200 | g | 200 | g |

| | | | |
|---|---|---|---|
| Oil content* | 5.2% | 5.3% | 5.4% |

| | | | | |
|---|---|---|---|---|
| **Tₘ | 40.8° | C. | 41.8° | C. |
| **T_{50%} | 36.3° | C. | 36.6° | C. |
| **T_{95%} | 53.7° | C. | 53.8° | C. |

*The oil contents of the extruded powders were measured by LF-NMR after overnight storage in the freezer and confirmation of full crystallization of fat via DSC;
**DSC measurements were conducted for the reconstituted extruded powders (10% in water) after overnight storage in the freezer.

### Example 7

Thermal Characterization of the Powdered Composition Prepared by Twin Screw Extrusion According to the Disclosure

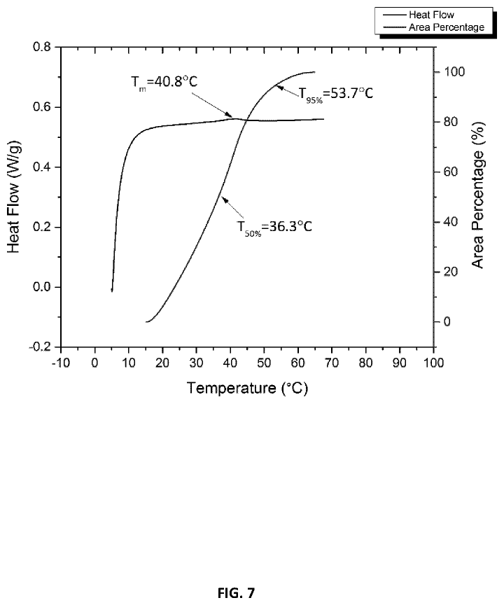

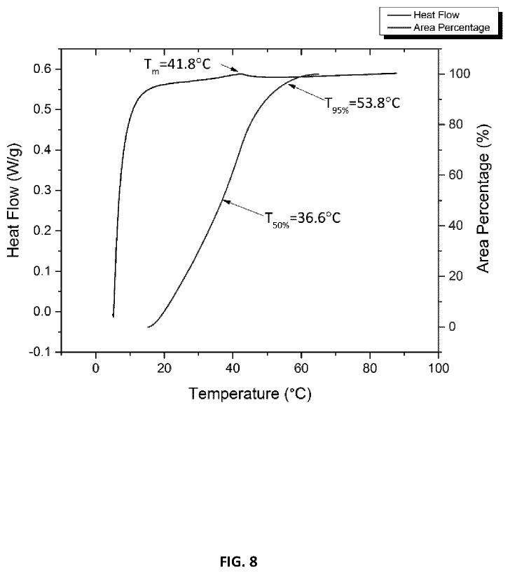

The extruded samples were reconstituted with water and analyzed by DSC as shown in FIG. 7 (Sample 1) and FIG. 8 (Sample J). The peaks on DSC graphs indicate the melting peak of crystallized fat in extruded powders. The Tₘ, T_{50%}, and T_{95%} of reconstituted powders were obtained from the DSC graph as described previously in protocol and methods.

1. A process for preparing a powdered composition, the process comprising the steps of:
(i) dispersing a dispersed phase, into a continuous phase comprising a carrier to obtain an oil-in-water emulsion, at a temperature above the melting peak temperature of the dispersed phase; wherein the dispersed phase comprises a lipid mixture comprising at least a plant-based fat and a flavor or perfume oil;
(ii) drying the oil-in-water emulsion of step (i) to obtain a powdered composition, at a temperature above the melting peak temperature of the dispersed phase; and
(iii) cooling the powdered composition of step (ii) to a temperature below the melting peak temperature of the dispersed phase.

2. The process of claim 1, wherein the lipid mixture comprises a plant-based fat and a flavor oil.

3. The process of claim 1, wherein the mixture drying comprises spray-drying.

4. The process of claim 1, wherein the weight ratio between the plant-based fat and the flavor oil or the perfume oil in the lipid mixture ranges between 5:95 to 95:5.

5. The process of claim 1, wherein the plant-based fat is selected from the group consisting of palm fat, shea butter, algae butter, mono-/di-glycerides, palmitic acid, stearic acid, lauric acid, hydrogenated vegetable oil, palm stearin, shea stearin, rice stearin, sunflower stearin, and mixtures thereof.

6. The process of claim 1, wherein the plant-based fat has a melting peak temperature ranging between 20° C. and 80° C.

7. The process of claim 1, wherein the carrier comprises at least one material selected from the group consisting of maltodextrin, inulin, plant-based proteins, gums, soluble fibers, soluble polysaccharides, and mixtures thereof.

8. The process of claim 1, wherein the continuous phase comprises an emulsifier which is selected from the group consisting of plant-based proteins, gum Arabic, modified food starch, Quillaja saponins, lecithin, and mixtures thereof.

9. A powdered composition comprising:
a carrier,
optionally an emulsifier; and
a lipid mixture comprising a solid plant-based fat and a flavor or perfume oil, wherein the the powdered composition has the following characteristics:
20° C.<Tₘ<70° C.; and
15° C.<T_{50%}<60° C.; and
20° C.<T_{95%}<80° C.; wherein
Tₘ represents melting peak temperature;
T_{50%} represents the temperature at which 50% by weight of solid plant-based fat melts; and
T_{95%} represents the temperature at which 95% by weight of solid plant-based fat melts.

10. The powdered composition of claim 9, wherein the lipid mixture is present in the powdered composition in an amount ranging between 5 percent by weight and 50 percent by weight, relative to the total weight of the powdered composition.

11. The powdered composition of claim 9, wherein the powdered composition comprises the emulsifier, and the emulsifier is present in an amount ranging between 5 percent by weight and 95 percent by weight, relative to the total weight of the powdered composition.

12. The powdered composition of claim 9, wherein the carrier is present in an amount ranging between 5 percent by weight and 95 percent by weight, relative to the total weight of the powdered composition.

13. A food, pet-food or feed product comprising the powdered composition as of claim 9.

14. The food, pet-food or feed product of claim 13, which further comprises vegetable proteins.

15. The food, pet-food or feed product of claim 13, which is in the form of meat analogue or a fish analogue.
